(19) United States
(12) Patent Application Publication
(10) Pub. No.: US 2010/0189940 A1
(43) Pub. Date: Jul. 29, 2010

(54) TITANIUM DIOXIDE-CONTAINING COMPOSITE

(75) Inventors: Sonja Grothe, Bottrop (DE); Petra Fritzen, Duisburg (DE); Jochen Winkler, Rheurdt (DE); Bernd Rohe, Dinslaken (DE); Birgit Bittmann, Kaiserslautern (DE); Frank Haupert, Stelzenberg (DE); Nicole Knör, Kaiserslautern (DE)

Correspondence Address: FULBRIGHT & JAWORSKI, LLP, 666 FIFTH AVE, NEW YORK, NY, 10103-3198, US

(73) Assignee: SACHTLEBEN CHEMIE GMBH, Duisburg (DE)

(21) Appl. No.: 12/438,646

(22) PCT Filed: Aug. 27, 2007
(86) PCT No.: PCT/EP2007/058894

§ 371 Date: Feb. 6, 2010

(30) Foreign Application Priority Data
Aug. 25, 2006 (DE) 102006039856.4

(51) Int. Cl. C08K 3/22; C08L 63/00; C09K 19/06; C08K 9/00; C08J 3/22; B32B 5/16; D02G 3/02; B32B 1/08

(52) U.S. Cl. 428/35.8; 523/442; 524/497; 252/299.6; 523/205; 523/209; 523/351; 428/328; 428/372

(57) ABSTRACT

The invention provides titanium-dioxide-containing composites, a method for their production and the use of these composites.

### FIELD OF THE INVENTION

The invention provides a titanium-dioxide-containing composite, a method for its production and the use of this composite.

### BACKGROUND AND SUMMARY OF THE INVENTION

From the application of conventional fillers and pigments, also known as additives, in polymer systems it is known that the nature and strength of the interactions between the particles of the filler or pigment and the polymer matrix influence the properties of a composite. Through selective surface modification the interactions between the particles and the polymer matrix can be modified and hence the properties of the filler and pigment system in a polymer matrix, hereinafter also referred to as a composite, can be changed. A conventional type of surface modification is the functionalisation of the particle surfaces using alkoxyalkylsilanes. The surface modification can serve to increase the compatibility of the particles with the matrix. Furthermore, a binding of the particles to the matrix can also be achieved through the appropriate choice of functional groups.

A second possibility for improving the mechanical properties of polymer materials is the use of ultrafine particles. U.S. Pat. No. 6,667,360 discloses polymer composites containing 1 to 50 wt. % of nanoparticles having particle sizes from 1 to 100 nm. Metal oxides, metal sulfides, metal nitrides, metal carbides, metal fluorides and metal chlorides are suggested as nanoparticles, the surface of these particles being unmodified. Epoxides, polycarbonates, silicones, polyesters, polyethers, polyolefines, synthetic rubber, polyurethanes, polyamide, polystyrenes, polyphenylene oxides, polyketones and copolymers and blends thereof are cited as the polymer matrix. In comparison to the unfilled polymer, the composites disclosed in U.S. Pat. No. 6,667,360 are said to have improved mechanical properties, in particular tensile properties and scratch resistance values.

A further disadvantage of the filler-modified composites described in the prior art is their inadequate mechanical properties for many applications.

### OBJECTS OF THE INVENTION

An object of the present invention is to overcome the disadvantages of the prior art.

An object of the invention is in particular to provide a composite which has markedly improved values for flexural modulus, flexural strength, tensile modulus, tensile strength, crack toughness, fracture toughness, impact strength and wear rates in comparison to prior-art composites.

For certain applications of composite materials, for example in the automotive or aerospace sector, this is of great importance. Thus reduced wear rates are desirable in plain bearings, gear wheels or roller and piston coatings. These components in particular should have a long life and hence lead to an extended service life for machinery. In synthetic fibres made from PA6, PA66 or PET, for example, the tear strength values can be improved.

Surprisingly the object was achieved with composites composite consisting of fillers and pigments in a polymer matrix, characterised in that it contains titanium dioxide, at least one thermoplastic, high-performance plastic and/or epoxy resin, wherein the crystallite size of the titanium dioxide d₅₀ is less than 350 nm, preferably less than 200 nm and particularly preferably between 3 and 50 nm, and the titanium dioxide can be both inorganically and/or organically surface-modified.

Surprisingly the mechanical and tribological properties of polymer composites were greatly improved even with the use of precipitated, surface-modified titanium dioxide having crystallite sizes d₅₀ of less than 350 nm (measured by the Debye-Scherrer method). Astonishingly, a physical bond between the particles and matrix has a particularly favourable effect on improving the mechanical and tribological properties of the composite.

### BRIEF DESCRIPTION OF THE FIGURES

FIG. 1 shows notched impact strength of the composites from Example 1 and 2 as a function of the particle content;

FIG. 2: shows the block and ring test set-up; and

FIG. 3 shows specific wear rate as a function of the contact pressure.

### DETAILED DESCRIPTION

The composite according to the invention contains a polymer matrix and 0.1 to 60 wt. % of precipitated titanium dioxide particles, with average crystallite sizes d₅₀ of less than 350 nm (measured by the Debye-Scherrer method). The crystallite size d₅₀ is preferably less than 200 nm, particularly preferably 3 to 50 nm. The titanium dioxide particles can have a spherical or bar-shaped morphology.

The composites according to the invention can also contain components known per se to the person skilled in the art, for example mineral fillers, glass fibres, stabilisers, process additives (also known as protective systems, for example dispersing aids, release agents, antioxidants, anti-ozonants, etc.), pigments, flame retardants (e.g. aluminium hydroxide, antimony trioxide, magnesium hydroxide, etc.), vulcanisation accelerators, vulcanisation retarders, zinc oxide, stearic acid, sulfur, peroxide and/or plasticisers.

A composite according to the invention can for example additionally contain up to 80 wt. %, preferably 10 to 80 wt. %, of mineral fillers and/or glass fibres, up to 10 wt. %, preferably 0.05 to 10 wt. %, of stabilisers and process additives (e.g. dispersing aids, release agents, antioxidants, etc.), up to 10 wt. % of pigment and up to 40 wt. % of flame retardant (e.g. aluminium hydroxide, antimony trioxide, magnesium hydroxide, etc.).

A composite according to the invention can for example contain 0.1 to 60 wt. % of titanium dioxide, 0 to 80 wt. % of mineral fillers and/or glass fibres, 0.05 to 10 wt. % of stabilisers and process additives (e.g. dispersing aids, release agents, antioxidants, etc.), 0 to 10 wt. % of pigment and 0 to 40 wt. % of flame retardant (e.g. aluminium hydroxide, antimony trioxide, magnesium hydroxide, etc.).

The polymer matrix can consist of a thermoplastic, a high-performance plastic or an epoxy resin. Polyester, polyamide, PET, polyethylene, polypropylene, polystyrene, copolymers and blends thereof, polycarbonate, PMMA or polyvinyl chloride, for example, are suitable as thermoplastic materials. PTFE, fluoro-thermoplastics (e.g. FEP, PFA, etc.), PVDF, polysulfones (e.g. PES, PSU, PPSU, etc.), polyetherimide, liquid-crystalline polymers and polyether ketones are suitable as high-performance plastics. Epoxy resins are also suitable as the polymer matrix.

The composite according to the invention can contain 0.1 to 60 wt. % of precipitated, surface-modified titanium dioxide, 0 to 80 wt. % of mineral fillers and/or glass fibres, 0.05 to 10 wt. % of stabilisers and process additives (e.g. dispersing aids, release agents, antioxidants, etc.), 0 to 10 wt. % of pigment and 0 to 40 wt. % of flame retardant (e.g. aluminium hydroxide, antimony trioxide, magnesium hydroxide, etc.).

According to the invention ultrafine titanium dioxide particles having an inorganic and/or organic surface modification can be used.

The inorganic surface modification of the ultrafine titanium dioxide typically consists of compounds containing at least two of the following elements: aluminium, antimony, barium, calcium, cerium, chlorine, cobalt, iron, phosphorus, carbon, manganese, oxygen, sulfur, silicon, nitrogen, strontium, vanadium, zinc, tin and/or zirconium compounds or salts. Sodium silicate, sodium aluminate and aluminium sulfate are cited by way of example.

The inorganic surface treatment of the ultrafine titanium dioxide takes place in an aqueous slurry. The reaction temperature should preferably not exceed 50° C. The pH of the suspension is set to pH values in the range above 9, using NaOH for example. The post-treatment chemicals (inorganic compounds), preferably water-soluble inorganic compounds such as, for example, aluminium, antimony, barium, calcium, cerium, chlorine, cobalt, iron, phosphorus, carbon, manganese, oxygen, sulfur, silicon, nitrogen, strontium, vanadium, zinc, tin and/or zirconium compounds or salts, are then added whilst stirring vigorously. The pH and the amounts of post-treatment chemicals are chosen according to the invention such that the latter are completely dissolved in water. The suspension is stirred intensively so that the post-treatment chemicals are homogeneously distributed in the suspension, preferably for at least 5 minutes. In the next step the pH of the suspension is lowered. It has proved advantageous to lower the pH slowly whilst stirring vigorously. The pH is particularly advantageously lowered to values from 5 to 8 within 10 to 90 minutes. This is followed according to the invention by a maturing period, preferably a maturing period of approximately one hour. The temperatures should preferably not exceed 50° C. The aqueous suspension is then washed and dried. Possible methods for drying ultrafine, surface-modified titanium dioxide include spray drying, freeze drying and/or mill drying, for example. Depending on the drying method, a subsequent milling of the dried powder may be necessary. Milling can be performed by methods known per se.

According to the invention the following compounds are particularly suitable as organic surface modifiers: polyethers, silanes, polysiloxanes, polycarboxylic acids, fatty acids, polyethylene glycols, polyesters, polyamides, polyalcohols, organic phosphonic acids, titanates, zirconates, alkyl and/or aryl sulfonates, alkyl and/or aryl sulfates, alkyl and/or aryl phosphoric acid esters.

Organically surface-modified titanium dioxide can be produced by methods known per se.

One option is surface modification in an aqueous or solvent-containing phase. Alternatively the organic component can be applied to the surface of the particles by direct spraying followed by mixing/milling.

According to the invention suitable organic compounds are added to a titanium-dioxide suspension whilst stirring vigorously and/or during a dispersion process. During this process the organic modifications are bound to the particle surface by chemisorption/physisorption.

Suitable organic compounds are in particular compounds selected from the group of alkyl and/or aryl sulfonates, alkyl and/or aryl sulfates, alkyl and/or aryl phosphoric acid esters or mixtures of at least two of these compounds, wherein the alkyl or aryl radicals can be substituted with functional groups. The organic compounds can also be fatty acids, optionally having functional groups. Mixtures of at least two such compounds can also be used.

The following can be used by way of example: alkyl sulfonic acid salt, sodium polyvinyl sulfonate, sodium-N-alkyl benzenesulfonate, sodium polystyrene sulfonate, sodium dodecyl benzenesulfonate, sodium lauryl sulfate, sodium cetyl sulfate, hydroxylamine sulfate, triethanol ammonium lauryl sulfate, phosphoric acid monoethyl monobenzyl ester, lithium perfluorooctane sulfonate, 12-bromo-1-dodecane sulfonic acid, sodium-10-hydroxy-1-decane sulfonate, sodium-carrageenan, sodium-10-mercapto-1-cetane sulfonate, sodium-16-cetene(1) sulfate, oleyl cetyl alcohol sulfate, oleic acid sulfate, 9,10-dihydroxystearic acid, isostearic acid, stearic acid, oleic acid.

The organically modified titanium dioxide can either be used directly in the form of the aqueous paste or can be dried before use. Drying can be performed by methods known per se. Suitable drying options are in particular the use of convection-dryers, spray-dryers, mill-dryers, freeze-dryers and/or pulse-dryers. Other dryers can also be used according to the invention, however. Depending on the drying method, a subsequent milling of the dried powder may be necessary. Milling can be performed by methods known per se.

According to the invention the surface-modified titanium dioxide particles optionally have one or more functional groups, for example one or more hydroxyl, amino, carboxyl, epoxy, vinyl, methacrylate and/or isocyanate groups, thiols, alkyl thiocarboxylates, di- and/or polysulfide groups.

Surface modifiers which are bound to the titanium dioxide particles by one functional group and which interact with the polymer matrix via another functional group are preferred.

The surface modifiers can be chemically and/or physically bound to the particle surface. The chemical bond can be covalent or ionic. Dipole-dipole or van der Waals bonds are possible as physical bonds. The surface modifiers are preferably bound by means of covalent bonds or physical dipole-dipole bonds.

According to the invention the surface-modified titanium dioxide particles have the ability to form a partial or complete chemical and/or physical bond with the polymer matrix via the surface modifiers. Covalent and ionic bonds are suitable as chemical bond types. Dipole-dipole and van der Waals bonds are suitable as physical bond types.

In order to produce the composite according to the invention a masterbatch can preferably be produced first, which preferably contains 5 to 80 wt. % of titanium dioxide. This masterbatch can then either be diluted with the crude polymer only or mixed with the other constituents of the formulation and optionally dispersed again.

In order to produce the composite according to the invention a method can also be chosen wherein the titanium dioxide is first incorporated into organic substances, in particular into polyols, polyglycols, polyethers, dicarboxylic acids and derivatives thereof, AH salt, caprolactam, paraffins, phosphoric acid esters, hydroxycarboxylic acid esters, cellulose, styrene, methyl methacrylate, organic diamides, epoxy resins and plasticisers (inter alia DOP, DIDP, DINP), and dispersed. These organic substances with added titanium dioxide can then be used as the starting material for production of the composite.

Conventional dispersing methods, in particular using melt extruders, high-speed mixers, triple roll mills, ball mills, bead mills, submills, ultrasound or kneaders, can be used to disperse the titanium dioxide in the masterbatch or in organic substances. The use of submills or bead mills with bead diameters of d<1.5 mm is particularly advantageous.

The composite according to the invention surprisingly has outstanding mechanical and tribological properties. In comparison to the unfilled polymer the composites according to the invention have markedly improved values for flexural modulus, flexural strength, tensile modulus, tensile strength, crack toughness, fracture toughness, impact strength and wear rates.

The invention provides in detail:
Composites consisting of at least one thermoplastic, at least one high-performance plastic and/or at least one epoxy resin and a precipitated, surface-modified titanium dioxide, whose crystallite size d₅₀ is less than 350 nm, preferably less than 200 nm and particularly preferably between 3 and 50 nm, and wherein the titanium dioxide can be both inorganically and/or organically surface-modified (hereinafter also referred to as titanium dioxide composites);
Titanium dioxide composites, wherein polyester, polyamide, PET, polyethylene, polypropylene, polystyrene, copolymers and blends thereof, polycarbonate, PMMA or PVC is used as the thermoplastic;
Titanium dioxide composites, wherein PTFE, fluoro-thermoplastics (e.g. FEP, PFA, etc.), PVDF, polysulfones (e.g. PES, PSU, PPSU, etc.), polyetherimide, liquid-crystalline polymers and polyether ketones are used as the high-performance plastic;
Titanium dioxide composites, wherein an epoxy resin is used as the thermoset;
Titanium dioxide composites, wherein the composite contains 12 to 99.8 wt. % of thermoplastic, 0.1 to 60 wt. % of precipitated, surface-modified titanium dioxide, 0 to 80 wt. % of mineral filler and/or glass fibre, 0.05 to 10 wt. % of antioxidant, 0 to 2.0 wt. % of organic metal deactivator, 0 to 2.0 wt. % of process additives (inter alia dispersing aids, coupling agents, etc.), 0 to 10 wt. % of pigment, and 0 to 40 wt. % of flame retardant (e.g. aluminium hydroxide, antimony trioxide, magnesium hydroxide, etc.);
Titanium dioxide composites, wherein the composite contains 12 to 99.9 wt. % of high-performance plastic, 0.1 to 60 wt. % of precipitated, surface-modified titanium dioxide, 0 to 80 wt. % of mineral filler and/or glass fibre, 0 to 5.0 wt. % of process additives (inter alia dispersing aids, coupling agents), 0 to 10 wt. % of pigment;
Titanium dioxide composites, wherein the composite contains 20 to 99.9 wt. % of epoxy resin, 0.1 to 60 wt. % of precipitated, surface-modified titanium dioxide, 0 to 80 wt. % of mineral filler and/or glass fibre, 0 to 10 wt. % of process additives, 0 to 10 wt. % of pigment and 0 to 40 wt. % of aluminium hydroxide;
Titanium dioxide composites, wherein the proportion of precipitated, surface-modified titanium dioxide in the composite is 0.1 to 60 wt. %, preferably 0.5 to 30 wt. %, particularly preferably 1.0 to 20 wt. %;
Titanium dioxide composites, wherein the titanium dioxide has an inorganic and/or organic surface modification;
Titanium dioxide composites, wherein the inorganic surface modification of the ultrafine titanium dioxide consists of a compound containing at least two of the following elements: aluminium, antimony, barium, calcium, cerium, chlorine, cobalt, iron, phosphorus, carbon, manganese, oxygen, sulfur, silicon, nitrogen, strontium, vanadium, zinc, tin and/or zirconium compounds or salts;
Titanium dioxide composites, wherein the organic surface modification consists of one or more of the following constituents: silanes, siloxanes, polysiloxanes, polycarboxylic acids, polyesters, polyethers, polyamides, polyethylene glycols, polyalcohols, fatty acids, preferably unsaturated fatty acids, polyacrylates, organic phosphonic acids, titanates, zirconates, alkyl and/or aryl sulfonates, alkyl and/or aryl sulfates, alkyl and/or aryl phosphoric acid esters;
Titanium dioxide composites, wherein the surface modification contains one or more of the following functional groups: hydroxyl, amino, carboxyl, epoxy, vinyl, methacrylate, and/or isocyanate groups, thiols, alkyl thiocarboxylates, di- and/or polysulfide groups;
Titanium dioxide composites, wherein the surface modification is covalently bound to the particle surface;
Titanium dioxide composites, wherein the surface modification is ionically bound to the particle surface;
Titanium dioxide composites, wherein the surface modification is bound to the particle surface by means of physical interactions;
Titanium dioxide composites, wherein the surface modification is bound to the particle surface by means of a dipole-dipole or van der Waals interaction;
Titanium dioxide composites, wherein the surface-modified titanium dioxide particles bond with the polymer matrix;
Titanium dioxide composites, wherein there is a chemical bond between the titanium dioxide particles and the polymer matrix;
Titanium dioxide composites, wherein the chemical bond between the titanium dioxide particles and the polymer matrix is a covalent and/or ionic bond;
Titanium dioxide composites, wherein there is a physical bond between the titanium dioxide particles and the polymer matrix;
Titanium dioxide composites, wherein the physical bond between the titanium dioxide particles and the polymer matrix is a dipole-dipole bond (Keeson), an induced dipole-dipole bond (Debye) or a dispersive bond (van der Waals);
Titanium dioxide composites, wherein there is a physical and chemical bond between the titanium dioxide particles and the polymer matrix;
Method for producing the titanium dioxide composites;
Method for producing the titanium dioxide composites, wherein a masterbatch is produced first and the titanium dioxide composite is obtained by diluting the masterbatch with the crude polymer, the masterbatch containing 5 to 80 wt. % of titanium dioxide, preferably 15 to 60 wt. % of titanium dioxide;
Method for producing the titanium dioxide composites, wherein the titanium-dioxide-containing masterbatch is diluted with the crude polymer and a dispersion preferably follows;
Method for producing the titanium dioxide composites, wherein the masterbatch is mixed with the other constituents of the formulation in one or more steps and a dispersion preferably follows;
Method for producing the titanium dioxide composites, wherein the titanium dioxide is first incorporated into organic substances, in particular into polyols, polyglycols, polyethers, dicarboxylic acids and derivatives thereof, AH salt, caprolactam, paraffins, phosphoric acid esters, hydroxycarboxylic acid esters, cellulose, styrene, methyl methacrylate, organic diamides, epoxy resins and plasticisers (inter alia DOP, DIDP, DINP), and dispersed;
Method for producing the titanium dioxide composites, wherein the organic substances with added titanium dioxide are used as the starting material for production of the composite;
Method for producing the titanium dioxide composites, wherein dispersion of the titanium dioxide in the masterbatch or in the organic substances is performed using conventional dispersing methods, in particular using melt extruders, high-speed mixers, triple roll mills, ball mills, bead mills, submills, ultrasound or kneaders;
Method for producing the titanium dioxide composites, wherein submills or bead mils are preferably used to disperse the titanium dioxide;
Method for producing the titanium dioxide composites, wherein bead mills are preferably used to disperse the titanium dioxide, the beads preferably having diameters of d<1.5 mm, particularly preferably d<1.0 mm, most particularly preferably d<0.3 mm;
Titanium dioxide composites having improved mechanical properties and improved tribological properties;
Titanium dioxide composites, wherein both the strength and the toughness are improved through the use of surface-modified titanium dioxide particles;
Titanium dioxide composites, wherein the improvement in the strength and toughness can be observed in a flexural test or a tensile test;
Titanium dioxide composites having improved impact strength and/or improved notched impact strength values;
Titanium dioxide composites, wherein the wear resistance is improved by the use of surface-modified titanium dioxide particles;
Titanium dioxide composites, wherein the scratch resistance is improved by the use of surface-modified titanium dioxide particles;
Titanium dioxide composites, wherein the stress cracking resistance is improved by the use of surface-modified titanium dioxide particles;
Titanium dioxide composites, wherein an improvement in the creep resistance can be observed;
Use of the titanium dioxide composites as a starting material for the production of moulded articles, semi-finished products, films or fibres, in particular for the production of injection moulded parts, blow mouldings or fibres;
Use of the titanium dioxide composites in the form of fibres, which are preferably characterised by improved tear strength values;
Use of the titanium dioxide composites for components for the automotive or aerospace sector, in particular in the form of plain bearings, gear wheels, roller or piston coatings;
Use of the titanium dioxide composites, for example for the production of components by casting, as an adhesive, as an industrial flooring, as a concrete coating, as a concrete repair compound, as an anti-corrosion coating, for casting electrical components or other objects, for the renovation of metal pipes, as a support material in art or for sealing wooden terrariums.

### DESCRIPTION OF PREFERRED EMBODIMENTS

The invention is illustrated by means of the examples below, without being limited thereto.

Production of inorganically surface-modified titanium dioxide:

3.7 kg of a 6.5 wt. % aqueous suspension of ultrafine titanium dioxide particles having average primary particle diameters d₅₀ of 14 nm (result of TEM analyses) are heated to a temperature of 40° C. whilst stirring. The pH of the suspension is adjusted to 12 using 10% sodium hydroxide solution. 14.7 ml of an aqueous sodium silicate solution (284 g SiO₂/I), 51.9 ml of an aluminium sulfate solution (with 75 g Al₂O₃/I) and 9.7 ml of a sodium aluminate solution (275 g Al₂O₃/I) are added simultaneously to the suspension whilst stirring vigorously and keeping the pH at 12.0. The suspension is homogenised for a further 10 minutes whilst stirring vigorously. The pH is then slowly adjusted to 7.5, preferably within 60 minutes, by adding a 5% sulfuric acid. This is followed by a maturing time of 10 minutes, likewise at a temperature of 40° C. The suspension is then washed to a conductivity of less than 100 μS/cm and then spray dried.

### Example 1

A precipitated, surface-modified titanium dioxide having a crystallite size d₅₀ of 14 nm is used as the starting material. The titanium dioxide surface is inorganically and organically surface-modified. The inorganic surface modification consists of an aluminium-oxygen compound. The organic surface modification consists of a polyalcohol. The polyalcohol enters into a physical interaction with the surface of the titanium dioxide. In a polyamide the remaining OH groups of the polyalcohol can enter into a dipole-dipole interaction with the carbonyl radicals (—C═O) of the polyamide.

First of all a 15 vol. % composite is produced from the specified titanium dioxide in polyamide 66 by means of extrusion. This material is used to make specimens for testing the flexural strength (as defined in DIN EN ISO 178), the tensile strength (as defined in DIN EN ISO 527), the impact strength (as defined in ASTM E399-90) and the creep strain (as defined in DIN EN ISO 899-1). The results of the test are set out in Tables 1 and 2. The use of the surface-modified titanium dioxide markedly improved the flexural strength, the flexural modulus, the impact strength, the tensile strength and the creep strain in comparison to the unfilled polyamide 66.

TABLE 1
Results of the 3-point bending test on the composite from
Example 1 in comparison to unfilled polyamide 66 (PA 66)

| | | Flexural |
|---|---|---|
| | Flexural strength | modulus |
| Sample | [MPa] | [MPa] |
| PA66 | 40 | 950 |
| PA66 + 15 vol. % surface-modified | 55 | 1420 |
| titanium dioxide | | |

TABLE 2
Tensile strength, impact strength and creep strain of the composite
from Example 1 in comparison to unfilled polyamide 66 (PA 66)

| | Tensile | Impact | |
|---|---|---|---|
| | strength | strength | Creep strain |
| Sample | [MPa] | [kJ/m²] | [%] |
| PA66 | 33 | 2.1 | 1.4 |
| PA66 + 15 vol. % surface-modified | 46 | 3.5 | 0.9 |
| titanium dioxide | | | |

### Example 2

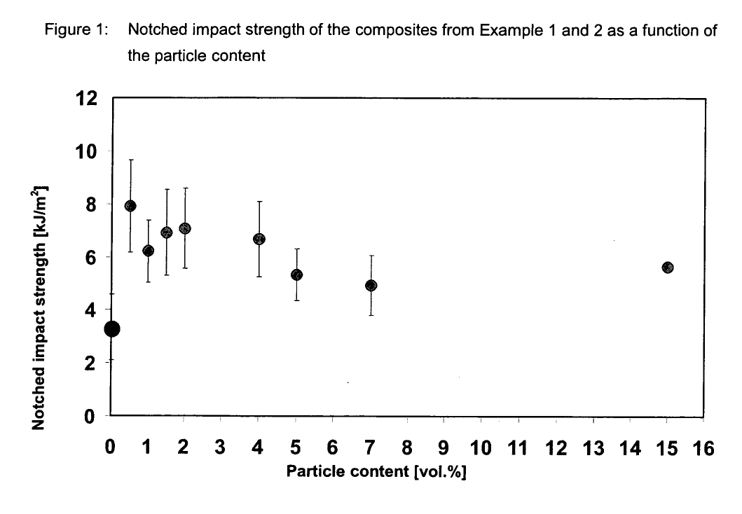

The 15 vol. % composite from Example 1 was diluted to particle contents of 0.5 to 7.0 vol. % by extrusion. These composites and the 15 vol. % composite were used to produce specimens for testing the Charpy notched impact strength (DIN EN ISO 179). The results of the notched impact strength test are shown in FIG. 1. The notched impact strength of the composites is significantly higher in comparison to the unfilled polyamide 66. Surprisingly, very low particle contents of 0.5 to 2.0 vol. % lead to the highest notched impact strength values.

### Example 3

A precipitated, surface-modified titanium dioxide having a crystallite size d₅₀ of 14 nm is used as the starting material. The titanium dioxide surface is inorganically and organically surface-modified. The inorganic surface modification consists of an aluminium-oxygen compound. The organic surface modification consists of a polyalcohol. The polyalcohol enters into a physical interaction with the surface of the titanium dioxide.

The commercially available epoxy resin Epilox A 19-03 from Leuna-Harze GmbH is used as the polymer matrix. The amine hardener HY 2954 from Vantico GmbH & Co KG is used as the hardener.

First of all the powdered titanium dioxide is incorporated into the liquid epoxy resin in a content of 14 vol. % and dispersed in a high-speed mixer. Following this pre-dispersion the mixture is dispersed for 90 minutes in a submill at a speed of 2500 rpm. 1 mm zirconium dioxide beads are used as the beads. This batch is mixed with the pure resin so that, after addition of the hardener, composites are formed containing 2 vol. % to 10 vol. % of titanium dioxide. The composites are cured in a drying oven.

### Example 4

For the mechanical tests on the composite from Example 3 described below, specimens with defined dimensions are produced. Mechanical characterisation is carried out in a three-point bending test as defined in DIN EN ISO 178 using specimens cut from cast sheets with a precision saw. At least five specimens measuring 80×10×4 mm³ are tested at room temperature at a testing speed of 2 mm/min.

The fracture toughness K_{IC} (as defined in ASTM E399-90) is determined at a testing speed of 0.1 mm/min using compact tension (CT) specimens. A sharp pre-crack was produced in the CT specimens by means of the controlled impact of a razor blade. This produces the plane strain condition at the crack tip necessary for determining the critical stress intensity factor.

The results of the flexural tests and the fracture toughness test are set out in Table 3. The composites according to the invention exhibit greatly improved properties in comparison to the pure resin. The flexural strength was able to be improved by 11%, the flexural modulus by as much as 45%, in comparison to the unfilled pure resin. The fracture strength was increased by approximately 40%.

TABLE 3
Results of the flexural test and the fracture toughness
test on the composites from Examples 3 and 4

| | Flexural | | Fracture |
|---|---|---|---|
| | modulus | Flexural strength | toughness |
| Sample | [MPa] | [MPa] | [MPa m^{1/2}] |
| Pure resin (Epilox A 19-03) | 2800 | 132 | 0.63 |
| Pure resin + 2 vol. % | 2900 | 134 | 0.80 |
| titanium dioxide | | | |
| Pure resin + 10 vol. % | 4100 | 148 | 0.88 |
| titanium dioxide | | | |

### Example 5

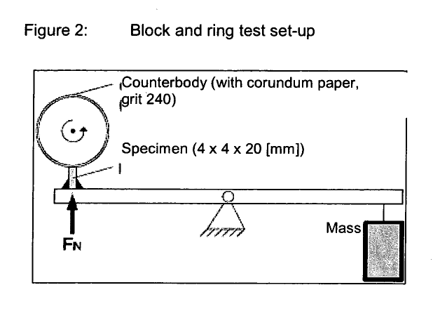

Specimens (pins) measuring 4×4×20 mm³ were cut from the composite from Example 3. The tribological properties of these specimens are characterised by means of the block and ring model test set-up (FIG. 2), which is used to perform abrasive wear tests. The abrasive test is carried out using ground needle bearing inner rings made from 100Cr6 steel with a diameter of 60 mm as the counterbody, the surface of which was modified by attaching corundum paper (grit 240) to increase the roughness. Before the start of the test the steel rings are cleaned with acetone to remove any residual oil or dirt contamination. The specimens were likewise cleaned and their initial mass m_{A} measured using a precision balance. To perform the wear tests the samples are pressed with a constant surface pressure p against the corresponding contact surface of the counterbody, which rotates at a constant speed. A weight of a defined mass generates the desired contact pressure or normal force F_{N} via a lever arm. All tests are performed at room temperature and for a test period of 30 seconds, the surface pressure p being varied systematically. For statistical reasons four samples of each material are tested. At the end of the test the wear-induced loss of weight Δm of the samples is determined. The specific wear rate wₛ can be calculated from this using the equation below:

$${w}_{S} = \frac{Δ m}{ρ {tvF}_{N}}$$

Δm: Loss of weight
ρ: Density
v: Rotational speed of the counterbody
t: Duration
F_{N}: Normal force

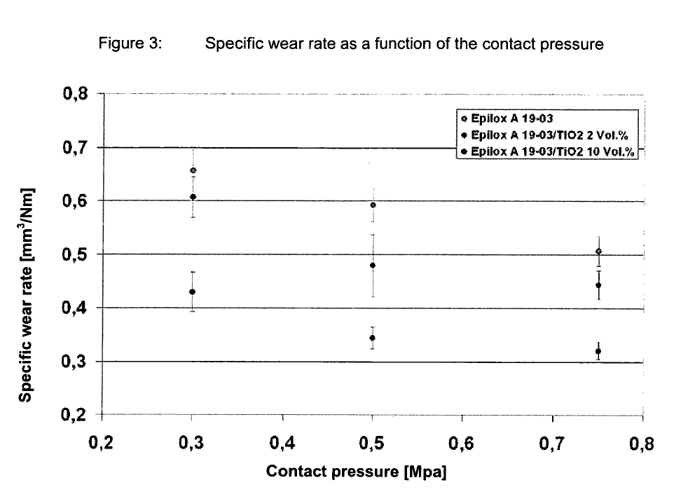

FIG. 3 shows the measured wear rate as a function of the contact pressure. Irrespective of the contact pressure, the wear rate of the composites according to the invention (Epilox A19-03/TiO₂ 2 vol. % and Epilox A19-03/TiO₂ 10 vol. %) is markedly lower than the wear rate of the pure resin. An improvement of up to 40% can be achieved overall.

### Example 6

A precipitated, surface-modified titanium dioxide having a crystallite size d₅₀ of 14 nm is used as the starting material. The titanium dioxide surface is inorganically and organically surface-modified. The inorganic surface modification consists of an aluminium-oxygen compound. The organic surface modification consists of an epoxy silane which can form covalent bonds with the polymer matrix.

The commercially available epoxy resin Epilox A 19-03 from Leuna-Harze GmbH is used as the polymer matrix. The amine hardener HY 2954 from Vantico GmbH & Co KG is used as the hardener.

First of all the powdered titanium dioxide is incorporated into the liquid epoxy resin in a content of 14 vol. % and dispersed in a high-speed mixer. Following this pre-dispersion the mixture is dispersed for 90 minutes in a submill at a speed of 2500 rpm. 1 mm zirconium dioxide beads are used as the beads. This batch is mixed with the pure resin so that after adding the hardener, composites are formed containing 2 vol. % to 10 vol. % of titanium dioxide. The composites are cured in a drying oven.

### Example 7

For the mechanical tests on the composite from Example 6 described below, specimens with defined dimensions are produced. Production of the specimens and the mechanical investigations of the specimens take place in an analogous manner to Example 4.

The results of the flexural tests and the fracture toughness test are set out in Table 4. The composites according to the invention exhibit greatly improved properties in comparison to the pure resin.

TABLE 4
Results of the flexural test and the test of fracture toughness

| | | | | Notched |
|---|---|---|---|---|
| | Flexural | Flexural | Fracture | impact |
| | modulus | strength | toughness | strength |
| Sample | [MPa] | [MPa] | [MPa m^{1/2}] | [kJ/m²] |
| Pure resin | 2380 | 69 | 0.63 | 0.9 |
| (Epilox A 19-03) | | | | |
| Pure resin + 1 vol. % | 3000 | 64 | 0.83 | n.d. |
| surface-modified titanium | | | | |
| dioxide with | | | | |
| dipole-dipole interactions | | | | |
| Pure resin + 2 vol. % | 2390 | 84 | 0.78 | 1.2 |
| surface-modified titanium | | | | |
| dioxide with | | | | |
| crosslinking groups | | | | |
| Pure resin + 10 vol. % | 3600 | 85 | 1.42 | 1.6 |
| surface-modified titanium | | | | |
| dioxide with | | | | |
| crosslinking groups | | | | |

1. Composite consisting of fillers and pigments in a polymer matrix, characterised in that it contains titanium dioxide, at least one thermoplastic, high-performance plastic and/or epoxy resin, wherein the crystallite size of the titanium dioxide d₅₀ is less than 350 nm, preferably less than 200 nm and particularly preferably between 3 and 50 nm, and the titanium dioxide can be both inorganically and/or organically surface-modified.

2. Composite according to claim 1, characterised in that at least one polyester, polyamide, PET, polyethylene, polypropylene, polystyrene, copolymers and/or blends thereof, polycarbonate, PMMA and/or polyvinyl chloride or mixtures of at least two of these thermoplastics are selected as the thermoplastic.

3. Composite according to claim 1 or 2, characterised in that at least one PTFE, fluoro-thermoplastic (e.g. FEP, PFA, etc.), PVDF, polysulfone (e.g. PES, PSU, PPSU, etc.), polyetherimide, liquid-crystalline polymer and/or polyether ketone or mixtures of at least two of these high-performance plastics are selected as the high-performance plastic.

4. Composite according to one or more of claims 1 to 3, characterised in that the composite contains 12 to 99.8 wt. % of thermoplastic, 0.1 to 60 wt. % of titanium dioxide, 0 to 80 wt. % of mineral filler and/or glass fibre, 0.05 to 10 wt. % of antioxidant, 0 to 2.0 wt. % of organic metal deactivator, 0 to 2.0 wt. % of process additives (inter alia dispersing aids, coupling agents, etc.), 0 to 10 wt. % of pigment, and 0 to 40 wt. % of flame retardant (e.g. aluminium hydroxide, antimony trioxide, magnesium hydroxide, etc.).

5. Composite according to one or more of claims 1 to 4, characterised in that the composite contains 12 to 99.9 wt. % of high-performance plastic, 0.1 to 60 wt. % of titanium dioxide, 0 to 80 wt. % of mineral filler and/or glass fibre, 0 to 5.0 wt. % of process additives (inter alia dispersing aids, coupling agents), 0 to 10 wt. % of pigment.

6. Composite according to one or more of claims 1 to 5, characterised in that the composite contains 20 to 99.9 wt. % of epoxy resin, 0.1 to 60 wt. % of titanium dioxide, 0 to 80 wt. % of mineral filler and/or glass fibre, 0 to 10 wt. % of process additives, 0 to 10 wt. % of pigment and 0 to 40 wt. % of aluminium hydroxide.

7. Composite according to one or more of claims 1 to 6, characterised in that the proportion of titanium dioxide in the composite is 0.1 to 60 wt. %, preferably 0.5 to 30 wt. %, particularly preferably 1.0 to 20 wt. %.

8. Composite according to one or more of claims 1 to 7, characterised in that the titanium dioxide is surface-modified with at least one inorganic and/or organic compound.

9. Composite according to claim 8, characterised in that the percentage by weight of inorganic compounds relative to titanium dioxide is 0.1 to 50.0 wt. %, preferably 1.0 to 10.0 wt. %.

10. Composite according to claim 8 or 9, characterised in that the inorganic compounds are selected from water-soluble aluminium, antimony, barium, calcium, cerium, chlorine, cobalt, iron, phosphorus, carbon, manganese, oxygen, sulfur, silicon, nitrogen, strontium, vanadium, zinc, tin and/or zirconium compounds or salts.

11. Composite according to one or more of claims 8 to 10, characterised in that the organic compounds are selected from one or more of the following compounds: silanes, siloxanes, polysiloxanes, polycarboxylic acids, polyesters, polyethers, polyamides, polyethylene glycols, polyalcohols, fatty acids, preferably unsaturated fatty acids, polyacrylates, organic phosphonic acids, titanates, zirconates, alkyl and/or aryl sulfonates, alkyl and/or aryl sulfates, alkyl and/or aryl phosphoric acid esters.

12. Composite according to one or more of claims 8 to 10, characterised in that the surface modification contains one or more of the following functional groups: hydroxyl, amino, carboxyl, epoxy, vinyl, methacrylate, and/or isocyanate groups, thiols, alkyl thiocarboxylates, di- and/or polysulfide groups.

13. Composite according to one or more of claims 8 to 12, characterised in that the surface-modified titanium dioxide particles bond with the polymer matrix.

14. Composite according to one or more of claims 1 to 13, characterised in that the titanium dioxide particles have a primary particle size d₅₀ of less than or equal to 0.1 μm, preferably 0.05 to 0.005 μm.

15. Method for producing a composite according to one or more of claims 1 to 14, characterised in that a masterbatch is produced from the titanium dioxide and part of the crude polymer and the composite is obtained by diluting the masterbatch with the crude polymer and dispersing it.

16. Method according to claim 15, characterised in that a masterbatch is produced from the titanium dioxide and part of the crude polymer and the composite is obtained by diluting the masterbatch with the crude polymer, wherein the masterbatch contains 5 to 80 wt. % of titanium dioxide, preferably 15 to 60 wt. % of titanium dioxide.

17. Method according to claim 15 or 16, characterised in that the masterbatch is mixed with the other constituents of the formulation in one or more steps and a dispersion preferably follows.

18. Method according to one or more of claims 15 to 17, characterised in that the titanium dioxide is first incorporated into organic substances, in particular into amines, polyols, styrenes, formaldehydes and moulding compositions thereof, vinyl ester resins, polyester resins or silicone resins, and dispersed.

19. Method according to claim 18, characterised in that the organic substances with added titanium dioxide are used as the starting material for production of the composite.

20. Method according to one or more of claims 15 to 19, characterised in that dispersion of the titanium dioxide in the masterbatch or in an organic substance is performed using conventional dispersing methods, in particular using melt extruders, high-speed mixers, triple roll mills, ball mills, bead mills, submills, ultrasound or kneaders.

21. Method according to one or more of claims 15 to 20, characterised in that dispersion of the titanium dioxide is preferably performed in submills or bead mills.

22. Method according to one or more of claims 15 to 21, characterised in that dispersion of the titanium dioxide is performed in bead mills, wherein beads having diameters of d<1.5 mm, particularly preferably d<1.0 mm, most particularly preferably d<0.3 mm, are used.

23. Use of a composite according to one or more of claims 1 to 14 as a starting material for the production of moulded articles, semi-finished products, films or fibres, in particular for the production of injection moulded parts, blow mouldings or fibres.

24. Use of a composite according to one or more of claims 1 to 14 for components for the automotive or aerospace sector, in particular in the form of plain bearings, gear wheels, roller or piston coatings.

25. Use of a composite according to one or more of claims 1 to 14 for the production of components by casting, as an adhesive, as an industrial flooring, as a concrete coating, as a concrete repair compound, as an anti-corrosion coating, for casting electrical components or other objects, for the renovation of metal pipes, as a support material in art or for sealing wooden terrariums.
